(19) United States
(12) Patent Application Publication
(10) Pub. No.: US 2015/0172829 A1
(43) Pub. Date: Jun. 18, 2015

(54) METHOD OF DETERMINING A FIT OF A HEARING DEVICE AND HEARING DEVICE WITH FIT RECOGNITION

(71) Applicant: SIEMENS MEDICAL INSTRUMENTS PTE. LTD., SINGAPORE (SG)

(72) Inventors: EVA DROSTE, ERLANGEN (DE); ULRICH GIESE, FUERTH (DE)

(21) Appl. No.: 14/568,717

(22) Filed: Dec. 12, 2014

(30) Foreign Application Priority Data
Dec. 12, 2013 (DE) 102013225760.0

(51) Int. Cl. H04R 25/00

(52) U.S. Cl. CPC H04R 25/30

(57) ABSTRACT

A method is shown which recognizes whether a hearing device system or a hearing device component is fitted correctly in an ear. To this end an acoustic test signal is output by an output device and is received again by a recording device. The test signal received back is compared to the permanently preset reference values of reference criteria in order thereby to obtain a status signal. The status signal contains information about the fit. In other words, it is possible to establish by the status signal whether the hearing device system is correctly fitted. Furthermore a hearing device system is shown which is suitable for performing the method.

### CROSS-REFERENCE TO RELATED APPLICATION

This application claims the priority, under 35 U.S.C. § 119, of German application DE 10 2013 225 760.0, filed Dec. 12, 2013; the prior application is herewith incorporated by reference in its entirety.

### BACKGROUND OF THE INVENTION

1. Field of the Invention

The present invention relates to a hearing device system which can be arranged fully or partially in the auditory canal. In addition, the present invention relates to a method for determining the fitting status of a hearing device or of a hearing device component on or in the ear.

A hearing device system here refers to any sound-emitting device which can be worn in or on the ear or on the head, for example a hearing device, a headset, headphones and the like. The term hearing device system also includes additional elements such as, for example, a remote control for a hearing device.

The fit or fitting status of a hearing device on the ear refers to a hearing device that is being worn or used. In particular a fitting status can have various qualitative gradations. In other words a hearing device can fit well and thus provide a good hearing result or else can fit less well and provide a hearing result that is not quite as good.

In principle it is difficult to assess the fit of a hearing device or of a hearing device component in the user's auditory canal from outside. But nor is the subjective assessment of the hearing device wearer as to the fit of his hearing device always meaningful. Another factor here is how much experience the hearing device wearer has with hearing devices. With small children in particular, there is the further problem that the auditory canal grows very rapidly, so that the fit of the hearing device or of the corresponding hearing device component constantly needs to be checked.

A further scenario would for example be that an inexperienced hearing device user purchases his hearing device via a sales channel such as the Internet. In this case it is not possible for an individual adjustment to be made by a hearing device acoustician. Consequently, in the absence of experience, it is possible that the user does not fit the hearing device correctly on the ear. Thus here too the optimum performance of the hearing device is not available to him. In principle, without assistance, he does not know whether the hearing system is fitted correctly.

Published, non-prosecuted European patent application EP 1 746 860 A2 shows a method for determining whether a hearing device is fitted correctly. Initially a first measurement is performed for this, in order to determine a first reference value. To this end when the hearing device is first worn a test signal is emitted by its receiver and is then received back by the microphone. In this case the proportion of the signal received back is measured and saved as a first reference. In normal operation of the hearing device in the ear a further such measurement is now performed. Subsequently the newly determined further value is then compared to the first reference value of the first measurement. The result should provide details of the correct fitting of the hearing device.

A disadvantage of this is that the hearing device could already have been positioned incorrectly in the ear at the time of the reference measurement. Thus the reference value would not be usable. To avoid this error, during the first measurement of the reference value specially trained personnel would have to be present, for example an experienced hearing device acoustician, and corresponding instruments would have to be used in order to prevent an erroneous reference measurement. This significantly restricts the freedom of use of the hearing device wearer.

In the aforementioned publication a microphone device is additionally required to record the measured signal in the auditory canal. The microphone normally used in hearing devices primarily has to receive sound from outside the auditory canal. It is consequently directed outward with its receive characteristic, even if it is positioned in the auditory canal, as in the case of a hearing device worn completely in the auditory canal. However, the measurement methods explained in the aforementioned publication work only in the region of the auditory canal, which is enclosed by the hearing device or the otoplastic on one side and the eardrum on the other side. Consequently the method of the aforementioned publication implicitly requires an additional microphone directed into the auditory canal. The fit is then determined on the basis of the loss of the captured signal strength emitted with the receiver into the auditory canal and reflected back there. Consequently to this end an additional microphone directed into the auditory canal must be used.

### SUMMARY OF THE INVENTION

The object of the invention is to create a hearing device and a method for determining the fit of a hearing device, in which the hearing device wearer is not reliant on specially trained personnel and their instruments.

The object is achieved by a method for determining the fit of a hearing device or of a hearing device component on the ear. The method includes transmitting a test signal as a transmit test signal from an output device of the hearing device, receiving at least a part of the transmit test signal as a received test signal by means of a recording device of the hearing device for sound, and comparing the received test signal using a signal processing device to at least one reference value of a reference criterion which is stored in the signal processing device. A status signal is generated in dependence on a result of the comparison between the received test signal and the at least one reference value. The status signal contains information about the fitting status of the hearing device, and the at least one reference value is preset and cannot be changed by a hearing device wearer.

The test signal is for example a sine signal or a broadband signal. The status signal is for example, depending on the intended purpose and embodiment, an electronic signal or an acoustic signal. This is explained in greater detail below in the exemplary embodiments. The statement that the reference value cannot be changed by the hearing device wearer means that he cannot by himself freely select or alter this value. It is permanently stored in a corresponding memory unit of the signal processing device. The reference value can thus only be altered by personnel with access to this memory unit, such as for example a hearing device acoustician.

In one embodiment the recording device in the form of a hearing device microphone assumes two tasks. First the noise is recorded and is fed to a signal processing unit, and second the signal from the ear is captured, which reaches the outside by passing the hearing device or an otoplastic used as a hearing device component. There it is compared to a preset, unchangeable reference value of a reference criterion which is preferably defined in the factory and for example is design-dependent or coupling-dependent. Preferably the reference value preset in the factory is based on measurements on typical head and/or ear shapes (e.g. the KEMAR dummy head) or a suitable mean value from measurements on different test subjects.

Depending on the embodiment it is also possible to use more than one recording device.

It is even possible for the recording device to be situated in or else outside the auditory canal and to be oriented inward or outward.

In one embodiment the reference criterion is a reference signal and the reference value is a signal value. In another embodiment the reference criterion is an attenuation and the reference value is an attenuation value.

In a further embodiment the reference criterion or reference value can also be the extent of a predefined deviation.

Furthermore it is possible to set different gradations of the deviations. The extent of the deviation of the received test signal from the original reference value is then measured and compared. For example, a deviation of 1 dB could easily be possible, 3 dB could still be regarded as acceptable, and 5 dB as an excessive deviation. These gradual gradations make it possible to subdivide the fit of the hearing device into positions of varying quality.

Preferably the reference criterion and/or reference value is a statistically determined variable or a signal. To this end hearing devices are adjusted as well as possible to the ear on several test persons and an open-loop-gain measurement is performed. In other words, this is the first measurement that has already been described above. Then for example a mean value is formed from the measurements with the test persons. The mean value is used as a reference value. The reference value is in turn saved in the hearing device and cannot be changed. Further open-loop-gain measurements as described above are performed during operation of the hearing device to detect the fit and are compared to the permanent, unchangeable reference value. Instead of forming a mean value as a reference value, a median, maxima or minima values, differential values or relative values are used.

This method is particularly suitable if the hearing device was not acquired in the traditional way from a hearing device acoustician who adjusted it properly, but from alternative sales channels such as the internet for example, where no individual adjustment is possible.

The entities designated here as reference criterion and reference value can also be interpreted and represented as a curve and associated values. For example, the reference criterion can also be regarded as a reference signal or as a reference curve.

In one embodiment the status signal is output by the output device. Preferably the output device is here a sound transducer and the status signal is thus an acoustic status signal. Furthermore, the output device is preferably a so-called receiver, a hearing device loudspeaker. The hearing device wearer can thus be notified, for example by voice output or a particular audible signal, whether his hearing device fits correctly.

In another embodiment the status signal is sent to an external transceiver unit. For example, the status signal can be sent by a wireless link to a remote control or a mobile telephone or smart phone. Examples of wireless links include radio links or magnetically induced links. At the external receive unit the status signal can then be output on a screen, by voice output, by a colored LED, etc.

In an advantageous development the status signal is a positive signal if the received test signal deviates from the reference value only within set limits. Conversely the status signal is a negative signal if the received test signal deviates from the reference value more than within set limits. Positive or negative signal here means a status report regarding a good or poor fit of the hearing device in the ear.

In one embodiment the status signal is determined anew at presettable time intervals. In other words regular time intervals can be set, at which the method is repeated. Thus a correct fit of the hearing device is checked at these regular intervals and is corrected if necessary. These intervals can, depending on the embodiment, be set either by a hearing device wearer and/or a hearing device acoustician.

In one embodiment the status signal is determined anew after the hearing device is switched on and/or put into the ear. Depending on the user the hearing device is switched off and back on again several times. Frequently the hearing device is to this end taken out of the ear and then put back again. Thus each time the hearing device is switched on the method for determining the correct fit in the ear is performed anew. In many cases the hearing device is switched on first and only then is positioned in or on the ear. In this case it does not make sense for the measurement to be taken until the device has also been positioned on the ear. For example, this is not the case until 30 seconds after switch-on. Thus a delay of the first run-through of the method can be set for example at 40 seconds after the switch-on.

In an advantageous development of this embodiment the method is started immediately or a set time after the hearing device is switched on, and is repeated as often as necessary until a correct or acceptable fit in the ear is identified. This is notified to the user by the status signal and as of this point in time the method is only repeated at longer time intervals. Every 5 minutes, for example. Alternatively the method can optionally be stopped again, i.e. after the correct fit is determined, so that it is no longer performed.

In one embodiment the recording device is directed in the direction of an external region outside the auditory canal of a user. For this variant the same microphone can be used as a recording device for the method as also records the sound from outside the auditory canal.

In one embodiment the recording device is directed in the direction of an internal region inside the auditory canal of a user. For this variant an additional recording device is needed, which records the sound inside the auditory canal. The advantage is that in this way the measurement accuracy for the method is increased.

Furthermore the object is achieved by a hearing device or a hearing device system with a recording device for recording sound and converting it into a signal, a signal processing device for processing the signal, and an output device for converting the processed signal into a sound signal and for outputting the sound signal. The signal processing device is suitable for comparing a test signal to at least one reference value of a reference criterion and consequently for generating a status signal. The status signal contains information about the fitting status of the hearing device. The output device is suitable for outputting test signals. The recording device is suitable for recording sound and for recording at least a part of the test signal. The at least one reference value is a preset value and cannot be changed by a hearing device wearer.

The recording device is preferably the microphone of the hearing device system. Hearing devices are normally equipped with one or two microphones. The output device is the receiver, the loudspeaker of the hearing device system. Preferably the microphone or microphones are directed to the outside of an auditory canal when the hearing device system is used. They are primarily configured to record the sound. In addition, however, a microphone can as here also be used as a receive device for test signals. Thus there is no need for an additional microphone for such test signals to be arranged on the hearing device, which is thus easier to manufacture.

In other embodiments an additional recording device directed into the auditory canal is possible. This recording device, normally embodied as a microphone, has the advantage that the measurement accuracy is higher if this is used to receive the test signal.

In an advantageous development the status signal is determined anew by a trigger function of an external transmit and/or receive unit. In this case the status signal can for example be forwarded to a remote control with a receive function. This could for example output the status signal acoustically or visually. It is also possible for the remote control to have transit functionality. This means it could trigger a measurement of the status signal by a trigger radio signal.

In an advantageous development the signal processing device is arranged in an external transmit and/or receive unit. The status signal is then generated there, in the external transmit and/or receive unit. The advantage of this is that the signal processing in part takes place remotely and thus the hearing device of the hearing device system has more resources available for other calculations.

Other features which are considered as characteristic for the invention are set forth in the appended claims.

Although the invention is illustrated and described herein as embodied in a method of determining a fit of a hearing device and a hearing device with fit recognition, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a hearing device in an auditory canal according to the invention;

FIG. 2 is a graph showing an open-loop-gain measurement with a good fit of a hearing device according to the invention; and

FIG. 3 is a graph showing an open-loop-gain measurement with a poor fit of a hearing device according to the invention.

### DETAILED DESCRIPTION OF THE INVENTION

Various embodiments are described below. This explicitly does not represent a definitive limitation of the invention to the embodiments described. Other different embodiments lying within the framework of the invention are possible.

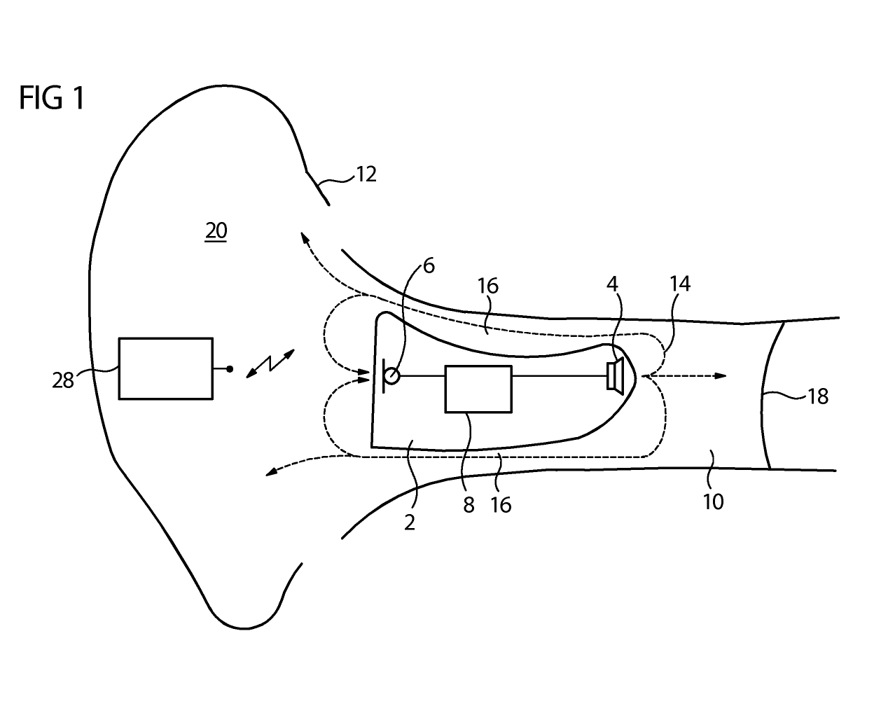

Referring now to the figures of the drawings in detail and first, particularly to FIG. 1 thereof, there is shown a hearing device 2 with an output device 4, a recording device 6 and a signal processing unit 8. The hearing device 2 is an in-the-ear hearing device (ITE), which fits into an auditory canal 10 of an ear 12 of a user. The dashed arrow lines represent a propagation of a test signal 14. When putting the hearing device 2 into the auditory canal 10 it transpires that there are air gaps 16 between the hearing device 2 and a wall of the auditory canal 10. Normally the smaller the dimensions of the air gaps 16 are, the better the correct fit of the hearing device 2. This is because larger air gaps 16 are associated with greater attenuation. Part of the sound is “lost”, as it were. The fit of the hearing device 2 is only sketched in FIG. 1, and hence the size of the air gap 16 is not true to scale.

A so-called open-loop-gain measurement is performed. In this case the output device 4 directed into the auditory canal 10 outputs a test signal 14. Part of the test signal 14 is directed on to an eardrum 18, while another part or a part reflected by the eardrum 18 passes through the air gaps 16 to an external region 20 outside the auditory canal 10. There the test signal 14 is received at least partially by the recording device 6. In this embodiment the output device 4 is a receiver and the recording device 6 is a microphone. Consequently the test signal 14 is a sound signal. More precisely, the received test signal 14 is only a part of the originally output test signal 14 which arrives at the recording device 6.

The rerecorded part of the test signal 14 is now compared in the signal processing unit 8 to at least one reference value of a reference criterion.

The reference value is a suitable value that can be compared to previously determined values of the test signal 14. Depending on the embodiment, the reference criterion can for example be an attenuation or a signal. Correspondingly, the reference value is an attenuation value or a signal value.

The reference value is already stored in the hearing device 2 as delivered. For example, this data is saved in a memory area of the signal processing unit 8. Hearing devices were adjusted as well as possible on several test persons by specialists, generally hearing device acousticians. Then an open-loop-gain measurement was performed on the hearing devices. A statistical mean value was then calculated from all test results. The result obtained in each case is designated here as reference criteria or reference values. These references can thus be regarded as an approximated value for an ideal fit of the hearing device 2 in the auditory canal 10. Instead of forming a mean value as a reference value, a median, maxima or minima values, differential values or relative values are used.

A result of the comparison between a rereceived test signal 14 and the reference value may for example be the extent of a deviation of the test signal 14 from the reference value. The smaller the deviation, the better the fit of the hearing device 4 in the auditory canal 10. A good fit increases the effectiveness of the hearing device 4.

This aforesaid measurement, the comparison of the test signal to the associated reference values, is referred to below as a test procedure.

To notify the user of the status of the hearing device fit, a status signal can be output to this end. Such a status signal can for example be output as a synthetic voice signal by the output device 4. In other words the hearing device tells the user whether or not it is correctly fitted. Another possibility is to transmit the status signal by a wireless radio link to a terminal such as a hearing device remote control for example.

The procedure for positioning and adjusting the hearing device 2 is as described below. First a user inserts the hearing device 2 into the auditory canal 10. The test procedure already described above now as it were tests the fit of the hearing device 2 in the auditory canal 10. If the fit of the hearing device is in need of improvement, the test procedure will ascertain this and will for example output the status signal “poor fit” by the output device 4. The user hears this output artificial sound signal and thereby recognizes that he ought to change the fit. After the user has adjusted the fit accordingly, the test procedure is executed anew. If the fit of the hearing device 2 is now assessed as good based on the result of the test procedure, the status signal “good fit” is output. The user now knows that he no longer needs to change the fit of the hearing device 2.

Various activities or automatisms could serve as a trigger for the test procedure. For example, it can be triggered by switching on the hearing device 2. It is furthermore possible to delay the start time of the test procedure after the switch-on, to give the user time to put the hearing device 2 into the auditory canal 10. The test procedure could also be automatically started anew at regular intervals and thus the user could also be notified regularly about the correctness of the fit of the hearing device. In this variant it is expedient to output the status signal only if the fit is poor. There is no need to tell the user that the fit is good, at least not on a regular basis. Preferably the user can himself set this interval. For example, this could be done by a hearing device remote control.

Instead of the in-the-ear device used in this embodiment, other models of hearing devices can also be used. For example, behind-the-ear devices or so-called receiver-in-canal devices as well.

Optionally the status signal can be transmitted to an external transmit and/or receive device 28. Furthermore the external transmit and/or receive device 28 is also suitable for triggering the determination of the status signal by a trigger function. The external transmit and/or receive device 28 can for example be a remote control with a transmit and/or receive function.

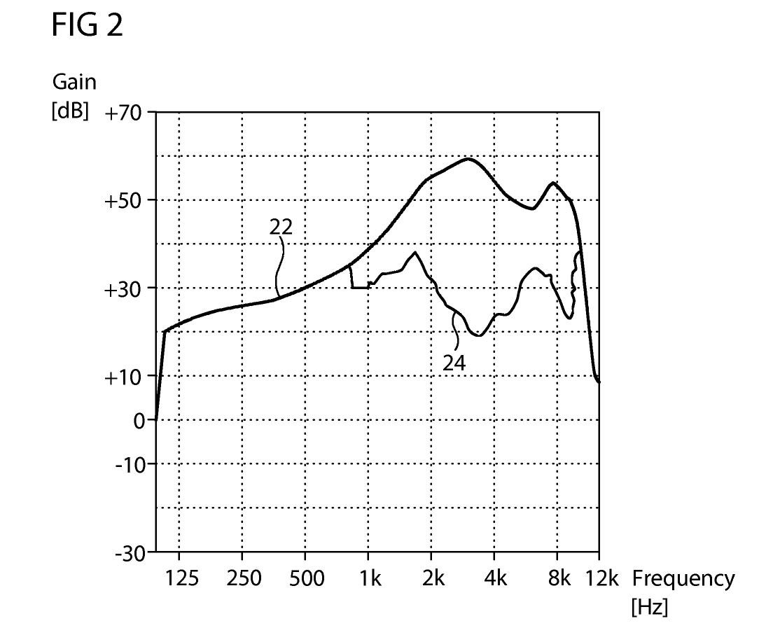

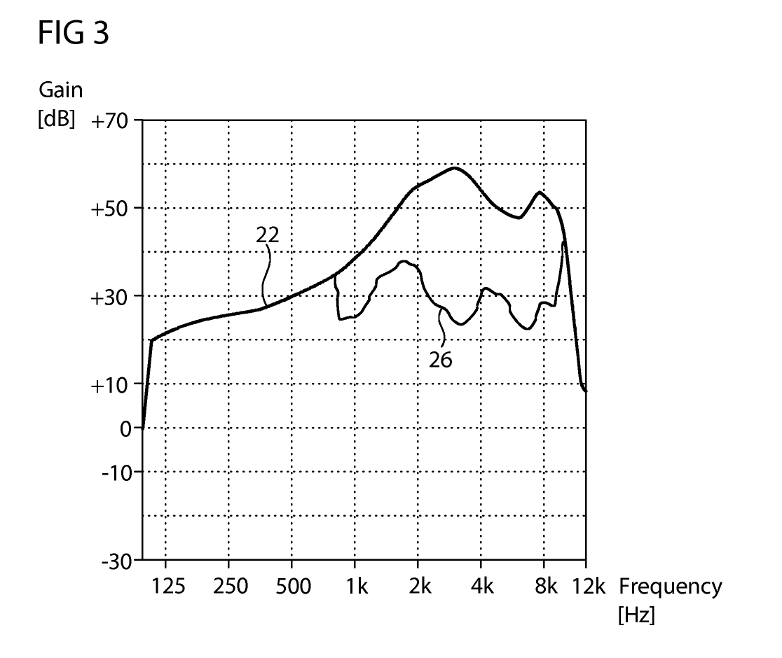

FIG. 2 and FIG. 3 graphically represent the measurement of different curves. The x-axis indicates a logarithmic frequency range from approximately 125 hertz to approximately 12,000 hertz. The y-axis shows an attenuation or gain in the logarithmic decibel unit.

A gain curve 22 represents a maximum possible gain of the hearing device. Test curves 24 and 26 are determined by performing the test procedure. The test curve 24 indicates a good fit of a hearing device in the ear. In contrast, the test curve 26 indicates a poor fit.

When considering the test curves 24 and 26, different gains in different frequency ranges are apparent. For example, the test curve 26 produced a gain value of about 25 dB during the measurement by the test procedure for the frequency value 1 kHz. Similarly, for the test curve 24 a value of about 30 dB was measured. For some frequency ranges the values of the test curve 24 are higher than for the test curve 26. But this is not the case for all of them.

In order now to be able to assess a measurement as good or less good, key frequency ranges are for example selected first. These are then assigned a threshold value. These different threshold values for the different frequency ranges can be regarded as reference values. A measurement is now performed using the test procedure. After the measurement a test curve is obtained such as the test curves 24 or 26 for example. It is then possible to compare whether and how often the reference values have been exceeded or undershot on the basis of the measurement. Based on the number of times the reference values have been exceeded or undershot, it is then possible to assume a good or a poor fit of the hearing device. Furthermore frequency ranges or corresponding threshold values regarded as more important can be weighted more heavily in this procedure. Thus in the method for determining the fit of the hearing device in the ear particular frequencies can be prioritized.

It is possible for the extent of a deviation in the measured values to be taken into account instead of merely distinguishing between the number of times the threshold values have been exceeded or undershot.

Alternatively a sum-total deviation of a signal curve can be used as reference values instead of individual threshold values.

Specifically for example a threshold value of at least 30 dB can be established for the frequencies 1 kHz and 7 kHz respectively. The test curve 24 exceeds these values, whereas the test curve 26 does not reach these threshold values. Thus for the test curve 24 a “good fit” can be specified and for the test curve 26 a “poor fit” of the hearing device.

1. A method for determining a fit of a hearing device or a component of the hearing device on and in an ear, which comprises the steps of:
transmitting a test signal as a transmit test signal from an output device of the hearing device;
receiving at least a part of the transmit test signal as a received test signal by a recording device of the hearing device for sound;
comparing the received test signal using a signal processing device to at least one reference value of a reference criterion stored in the signal processing device; and
generating a status signal in dependence on a result of a comparison between the received test signal and the at least one reference value, the status signal containing information about a fitting status of the hearing device, and the at least one reference value is preset and cannot be changed by a hearing device wearer.

2. The method according to claim 1, wherein the reference criterion is a reference signal and the reference value is a signal value.

3. The method according to claim 1, wherein the reference criterion is an attenuation and the reference value is an attenuation value.

4. The method according to claim 1, which further comprises outputting the status signal via the output device.

5. The method according to claim 4, wherein the output device is a sound transducer which outputs the status signal as an acoustic signal.

6. The method according to claim 1, which further comprises transmitting the status signal to an external transmit and/or receive unit.

7. The method according to claim 1, which further comprises performing the method anew at preset table time intervals.

8. The method according to claim 1, which further comprises performing the method anew after the hearing device has been switched on and/or put into the ear.

9. The method according to claim 1, which further comprises directing the recording device in a direction of an external region outside an auditory canal of a user.

10. The method according to claim 1, which further comprises directing the recording device in a direction of an internal region inside an auditory canal of a user.

11. A hearing device system, comprising:
a hearing device;
a recording device disposed on or in said hearing device for recording sound and converting the sound into a signal;
a signal processing device for processing a signal and connected to said recording device;
an output device disposed on or in said hearing device for converting a processed signal into a sound signal and outputting the sound signal, said output device connected to said signal processing device;
said signal processing device programmed to compare a test signal to at least one reference value of a reference criterion and consequently for generating a status signal, the status signal containing information about a fitting status of said hearing device, the at least one reference value being a preset value and cannot be changed by a hearing device wearer;
said output device configured for outputting a test signal; and
said recording device recording the sound and recording at least a part of the test signal.

12. The hearing device system according to claim 11, wherein the status signal is determined anew at preset table time intervals.

13. The hearing device system according to claim 11, wherein the status signal is determined anew after said hearing device is switched on and/or put into an ear.

14. The hearing device system according to claim 11, further comprising an external transmit and/or receive unit, the status signal is determined anew by means of a trigger function of said external transmit and/or receive unit.

15. The hearing device system according to claim 14, wherein said signal processing device is disposed in said external transmit and/or receive unit and the status signal is generated there.
